(19) United States
(12) Patent Application Publication
(10) Pub. No.: US 2019/0184564 A1
(43) Pub. Date: Jun. 20, 2019

(54) ROBOT CONTROL APPARATUS AND ROBOT CONTROL METHOD

(71) Applicant: HONDA MOTOR CO., LTD., Tokyo (JP)

(72) Inventors: Kotaro Muraoka, Hagagun, Tochigi (JP); Yasutaka Ishizuka, Hagagun, Tochigi (JP)

(21) Appl. No.: 16/328,063

(22) PCT Filed: Mar. 17, 2017
(86) PCT No.: PCT/JP2017/010887

§ 371 Date: Feb. 25, 2019

(30) Foreign Application Priority Data
Aug. 30, 2016 (JP) 2016-168350

(51) Int. Cl. B25J 9/16; B25J 13/08

(52) U.S. Cl. CPC B25J 9/1687; B25J 13/085; B23P 19/04; B25J 9/163; B25J 9/1633; B25J 9/1612

(57) ABSTRACT

A robot control apparatus includes: a memory unit configured to store a correspondence-relation between a plurality of half-mounted-states of a first component and an optimal action of a robot giving the highest reward for each of the plurality of half-mounted-states obtained beforehand by reinforcement learning; a force detector configured to detect a half-mounted-state of the first component; and a normal control unit configured to identify an optimal action of the robot corresponding to the half-mounted-state detected by the force detector based on the correspondence-relation stored in the memory unit and to control the servo motor in accordance with the optimal action.

### TECHNICAL FIELD

This invention relates to a control apparatus and a control method for a robot performing press-fitting operation and other operation.

### BACKGROUND ART

There have been known devices that are mounted on the hands of robots and reduce the reaction force during a press-fitting operation (for example, see Patent Literature 1). Patent Literature 1 discloses a press-fitting device that press-fits an axial component into a press-fitting hole formed in a workpiece into which the axial component is to be press-fitted. This press-fitting device includes press-fitting means that is swingably supported by a mounting member with a pair of springs therebetween. Thus, when the axial component receives an eccentric load from the edge of the press-fitting hole, the press-fitting means swings and reduces the press-fitting reaction force.

### CITATION LIST

### Patent Literature

Patent Literature 1: Japanese Unexamined Patent Publication No. 2006-116669

### DISCLOSURE OF INVENTION

### Problems to be Solved by the Invention

However, the device described in Patent Literature 1 only reduces the press-fitting reaction force. For example, if there is a misalignment or the like between the axial component and the press-fitting hole due to the individual differences between axial components, it is difficult to press-fit the axial component even if the device described in Patent Literature 1 is used.

### Means for Solving Problem

An aspect of the present invention is a robot control apparatus configured to control a robot so as to mount a first component supported by a hand of the robot driven by an actuator to a second component, including: a memory unit configured to store a correspondence-relation between a plurality of half-mounted-states of the first component and an optimal action of the robot giving the highest reward for each of the plurality of half-mounted-states obtained beforehand by reinforcement learning; a state detecting unit configured to detect a half-mounted-state of the first component; and an actuator controller configured to identify an optimal action of the robot corresponding to the half-mounted-state detected by the state detecting unit based on the correspondence-relation stored in the memory unit and to control the actuator in accordance with the optimal action.

Another aspect of the present invention is a robot control method controlling a robot so as to mount a first component supported by a hand of the robot driven by an actuator to a second component. The robot control method including: a reinforcement learning step acquiring a correspondence-relation between a plurality of half-mounted-states of the first component and an optimal action of the robot giving the highest reward for each of the plurality of half-mounted-states by mounting the first component to the second component multiple times by driving the hand; and a mounting step, when mounting the first component to the second component, detecting a half-mounted-state of the first component, identifying an optimal action corresponding to the half-mounted-state detected based on the correspondence-relation acquired in the reinforcement learning step, and controlling the actuator in accordance with the optimal action identified.

### Effect of the Invention

According to the present invention, reinforcement learning is used. Thus, even if there is a misalignment or the like between the first component and the second component, the first component can be easily mounted on the second component by actuating the hand of the robot.

### BRIEF DESCRIPTION OF DRAWINGS

FIG. 1 is a drawing schematically showing a robot system including a robot control apparatus according to an embodiment of the present invention;

FIG. 2 is an enlarged view of a front arm end of a robot in FIG. 1;

FIG. 3A is a drawing showing a bending state of a workpiece during mounting operation of the workpiece;

FIG. 3B is a drawing showing a bulking state of the workpiece during mounting operation of the workpiece;

FIG. 4 is a drawing showing an example of a reference movement path during mounting operation of the workpiece;

FIG. 5 is a drawing showing half-mounted-states of the workpiece;

FIG. 6 is a diagram showing an example of a reward table used in Q-learning;

FIG. 7 is a drawing showing a part of FIG. 4 and showing a movement path of the workpiece;

FIG. 8 is a drawing showing actions that the robot can take during mounting the workpiece;

FIG. 9 is a graph showing relationship between a number of attempts of a hand and a Q-value;

FIG. 10A is a diagram showing an example of a Q-table obtained in a reinforcement learning step;

FIG. 10B is a diagram showing another example of the Q-table obtained in the reinforcement learning step;

FIG. 11 is a diagram showing a specific example of the Q-table; and

FIG. 12 is a flowchart showing an example of processing performed by a normal control unit in FIG. 1.

### DESCRIPTION OF EMBODIMENT

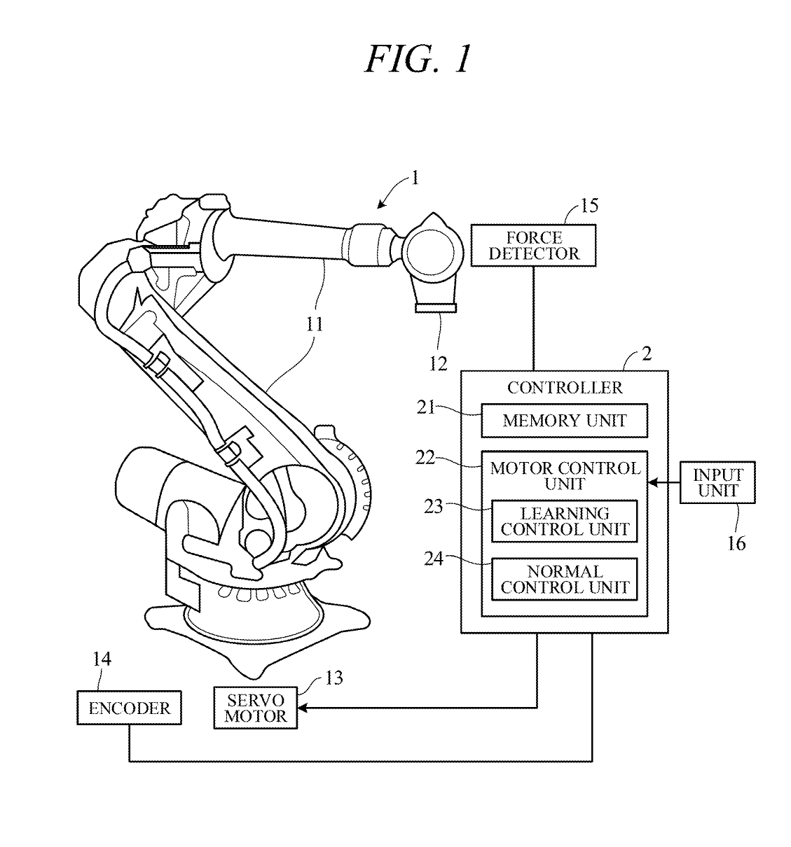

An embodiment of the present invention will be described with reference to FIGS. 1 to 12. FIG. 1 is a drawing schematically showing a robot system including a robot control apparatus according to the embodiment of the present invention. This robot system includes a robot 1 and a controller 2 that controls the robot 1. The controller 2 includes a programmable logic controller (PLC), a servo amplifier, and the like.

The robot 1 is, for example, a vertical articulated robot having multiple rotatable arms 11, and the front arm end is provided with a working hand 12. The robot 1 has multiple (for convenience, only one is shown) servo motors 13 for actuating the robot. Each servo motor 13 is provided with an encoder 14 that detects the rotation angle of the servo motor 13. The detected rotation angle is fed back to the controller 2, which then feedback-controls the position and posture of the hand 12 in a three-dimensional space.

The controller 2 includes an arithmetic processing unit including a CPU, ROM, RAM, and other peripheral circuits. The controller 2 outputs a control signal to the servo motor 13 in accordance with a program stored in the memory beforehand, to control the operation of the robot 1. While the robot 1 performs various types of operations, the robot 1 according to the present embodiment is configured to perform, among others, mounting of a workpiece on a component.

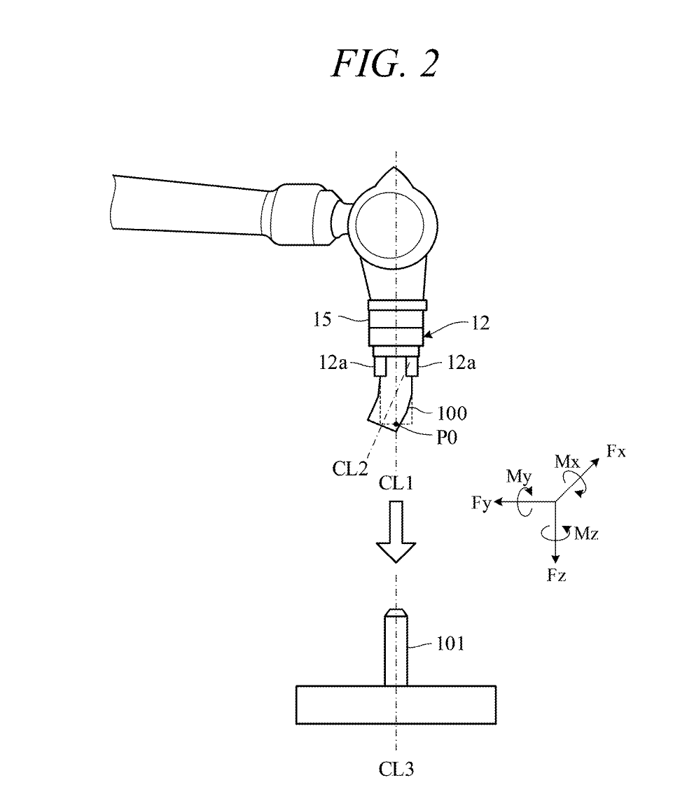

FIG. 2 is an enlarged view of the front arm end of the robot 1. As shown in FIG. 2, the hand 12 includes claws 12a that expand and contract around an axis CL1 and is able to grasp a workpiece 100 around the axis CL1 by means of the claws 12a. The workpiece 100 is, for example, a tube formed of a flexible material (rubber, etc.). The workpiece 100 is mounted on, for example, a component (e.g., a pipe) 101 disposed so as to protrude from an engine and formed of a harder material (a metal, etc.) than the workpiece 100. Mounting of the workpiece 100 is performed by press-fitting the workpiece 100 into the outside of the component 101. The workpiece 100 and component 101 form a channel through which a fluid flows into and out of the engine.

Prior to mounting the workpiece 100, a reference workpiece shape is defined. For example, if the workpiece 100 is a tube as in the present embodiment, a cylindrical reference workpiece shape (dotted line) around the axis CL1 is defined. Also, a reference point P0 is set at the front end of the hand 12. The workpiece is mounted by controlling the position of the reference point P0. For example, as shown in FIG. 2, the reference point P0 is set at a point of the front end of the reference workpiece shape on the axis CL1. Note that the reference point P0 may be set at a point away from the mounting portion of the hand 12 by a predetermined distance (e.g., the front end of a claw 12a).

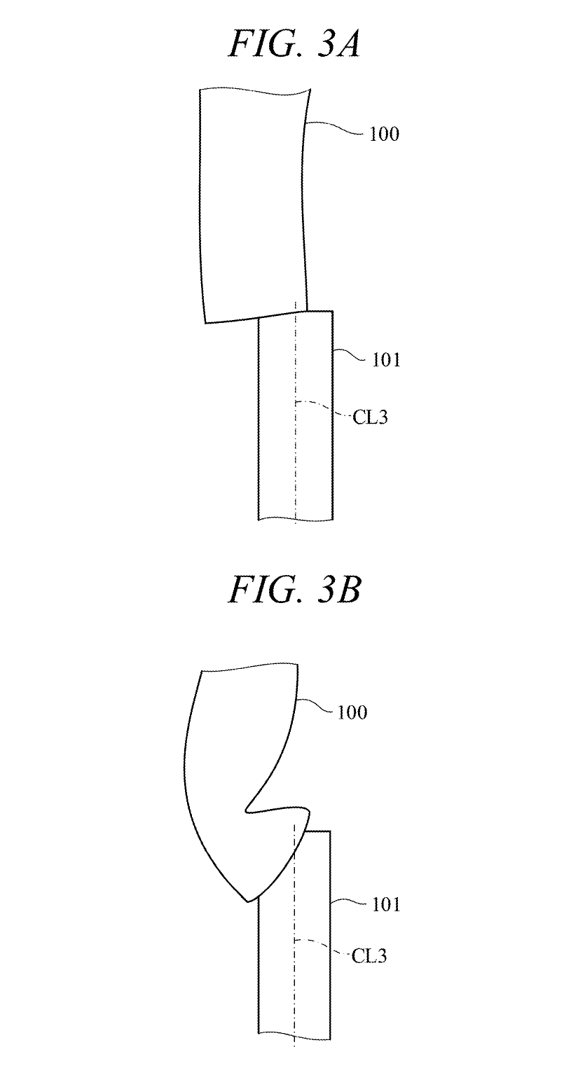

The tubular workpiece 100 has an inherent bending tendency and therefore there are individual differences in shape between workpieces. Such individual differences also occur due to the differences between the molding conditions or the like of workpieces 100. Further, the physical properties (elastic modulus, etc.) of the workpiece 100 may change due to a change in temperature or humidity during operation. Consequently, as shown in FIG. 2, a misalignment occurs between the axis CL1 and the central axis CL2 of the front end of the workpiece. Thus, when the workpiece 100 is mounted by operating the hand 12 along a predefined track (position control), a bend (as shown in FIG. 3A), buckling (as shown in FIG. 3B), or the like may occur in the workpiece 100.

An example approach to avoid the bend, buckling, or the like of the workpiece 100 is to dispose, on the hand 12, a reaction force receiver that reduces the press-fitting reaction force. However, the disposition of such a receiver complicates the configuration of the hand 12 and upsizes the hand 12. Also, even if the force acting on the hand 12 is controlled by disposing, on the hand 12, the reaction force receiver or a sensor or the like that detects such a force (force control), it is difficult to quickly press-fit the flexible workpiece 100, such as a tube. In particular, if there is a misalignment between the workpiece 100 and the component 101, it is difficult to press-fit the workpiece 100 while resolving the misalignment. For these reasons, in the present embodiment, the robot control apparatus is configured as follows such that the workpiece 100 is quickly press-fitted without complicating the configuration of the hand 12.

As shown in FIG. 1, the controller 2 receives signals from the encoder 14, as well as from a force detector 15 and an input unit 16.

As shown in FIG. 2, the force detector 15 includes a 6-axis force sensor disposed on an end of the hand 12. Here, the direction of the axis CL1 is defined as a Z-direction, and two perpendicular axial directions forming a plane perpendicular to the axis CL1 are defined as X- and Y-directions. The force detector 15 detects translational forces Fx, Fy, and Fz in the X-axis, Y-axis, and Z-axis directions and moments Mx, My, and Mz around the X-axis, Y-axis, and Z-axis acting on the hand 12. The Z-direction is the movement direction (along the axis CL1) of the hand 12, and the Y-direction is the direction in which a misalignment occurs between the axis CL3 of the component 101 and the central axis CL2 of the front end of the workpiece. That is, the robot 1 operates such that a misalignment occurs between the components in a YZ-plane, and the hand 12 moves in the YZ-plane such that the misalignment is corrected.

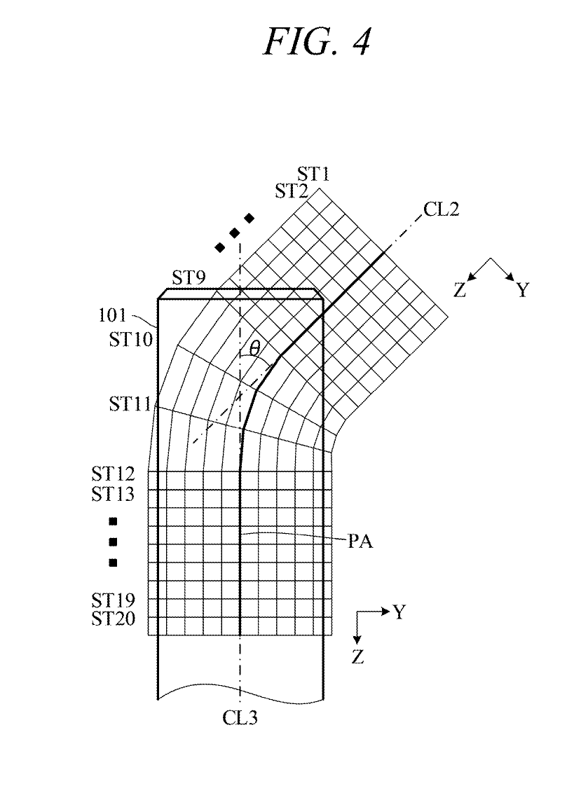

The input unit 16 in FIG. 1 includes a keyboard, touchscreen, or the like, and the controller 2 receives commands, set values, the reference workpiece shape, and the like relating to a mounting operation through the input unit 16. The robot 1 according to the present embodiment is able to perform a normal workpiece mounting operation in accordance with a command from the controller 2, as well as to perform an operation as reinforcement learning. The robot 1 receives also a command to switch between these operations through the input unit 16. Set values required for reinforcement learning, for example, a movement path serving as the reference of the front end (the reference point P0) of the hand (a reference movement path PA in FIG. 4) and the amount of movement (pitch) per unit time are also set through the input unit 16.

The controller 2 includes a memory unit 21 and a motor control unit 22 as functional elements. The motor control unit 22 includes a learning control unit 23 that controls the servo motor 13 during reinforcement learning and a normal control unit 24 that controls the servo motor 13 during a normal workpiece mounting operation. The memory unit 21 stores a correspondence-relation between half-mounted-states of the workpiece 100 and actions of the robot 1 (a Q table (to be discussed later)). In the reinforcement learning step, the learning control unit 23 drives the servo motor 13 to mount the workpiece 100 on the component 101 multiple times. Reinforcement learning will be described below.

Reinforcement learning is a type of machine leaning that addresses an issue in which an agent in an environment observes the current state and determines an action to be taken. The agent obtains a reward from the environment by selecting an action. While there are various reinforcement learning techniques, Q-learning is used in the present embodiment. Q-leaning is a technique that performs leaning such that an action having the highest action evaluation function value (Q-value) (an action that receives the greatest amount of reward) is taken in a certain environment.

The Q-value is updated by the following formula (I) on the basis of a state sₜ and an action aₜ at time t.

Q(sₜ, aₜ)←Q(sₜ, aₜ)+α[rₜ₊₁+γₘₐₓQ(sₜ₊₁, aₜ₊₁)−Q(sₜ, aₜ)] (I)

In the formula (I), α is a coefficient (leaning rate) representing the degree to which the Q-value is updated, and γ is a coefficient (discount rate) representing the degree to which the result of an event which may occur from now on is reflected. The coefficients α, γ are properly adjusted and set within 0<α≤1 and 0<γ≤1, respectively, on the basis of experience. Also, r is an index (reward) for evaluating the action at with respect to a change in the state sₜ and is set such that the Q-value is increased when the state sₜ becomes better.

What should be done first to perform an operation as reinforcement learning is to define the reference movement path through which the workpiece 100 moves in the period from the start to the end of its mounting. FIG. 4 is a drawing showing an example of the reference movement path PA. The reference movement path PA is determined considering the manner in which an operator skilled in mounting the workpiece 100 actually manually press-fits the workpiece 100.

Specifically, to press-fit the flexible workpiece 100 into the outside of the component 101, the operator first grasps the front end of the workpiece 100 and inserts the front end into the peripheral surface of the component 101 obliquely at a predetermined angle θ (e.g., 45°) with respect to the axis CL3. The operator then rotates the workpiece 100 so that the central axis CL2 of the workpiece 100 is aligned with the axis CL3, and then presses the workpiece 100 along the axis CL3 until the workpiece reaches a predetermined position while keeping the posture of the workpiece. Considering this aspect, the reference movement path PA used when the robot 1 press-fits the workpiece 100 is defined on the YZ-plane, as shown in FIG. 4. Note that in FIG. 4, the operation direction (Z-direction) of the hand 12 changes along the reference movement path PA and thus the Y-direction perpendicular to the Z-direction also changes.

In FIG. 4, the path from the mounting start position immediately before the front end (reference point P0) of the workpiece 100 contacts the component 101 to the mounting end position in which the front end of the workpiece is press-fitted until it reaches the predetermined position is divided into multiple (e.g., 20) steps (ST1 to ST20) along the reference movement path PA. The time t in the formula (I) is replaced with a step, and a Q-value is calculated for each step. In steps ST1 to ST9, the workpiece 100 is inserted obliquely with respect to the axis CL3, in steps ST10 to ST12, the workpiece 100 is rotated, and in steps ST13 to ST20, the workpiece 100 is pressed into the component 101 along the axis CL3. Hereafter, the current step, the immediately preceding step, and the immediately following step in the workpiece mounting operation may be referred to as STₜ, STₜ₋₁, and STₜ₊₁, respectively.

To cause the robot 1 to perform a workpiece mounting operation as reinforcement learning (Q-leaning), it is necessary to define the states of the workpiece 100 in the period from the start to the end of mounting of the workpiece 100 (the half-mounting states of the workpiece 100) and actions that the robot 1 can take. First, the half-mounted-states of the workpiece 100 will be described.

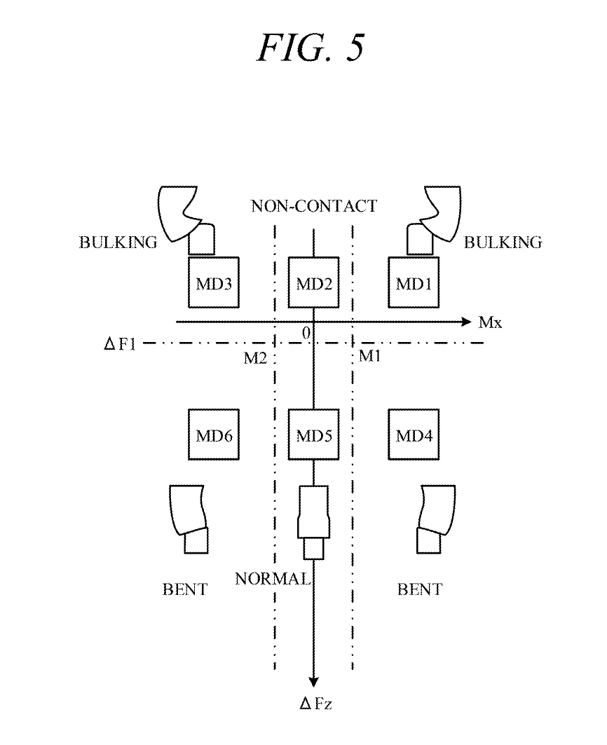

FIG. 5 is a drawing showing the half-mounted-states of the workpiece 100 that moves in the YZ-plane. As shown in FIG. 5, the half-mounted-states of the workpiece 100 are classified into 6 states, that is, modes MD1 to MD6 in accordance with the amount of change ΔFz of a force Fz in the axis CL2 direction (Z-direction) acting on the front end of the hand and the moment Mx around the X-axis perpendicular to the YZ-plane acting on the front end of the hand.

The amount of change ΔFz of the force is the difference between the force Fz acting on the workpiece in the current step STₜ and the force Fz that has acted on the workpiece in the immediately preceding step STₜ₋₁. For example, when the current step is ST3, the difference between the force Fz acting in step ST3 and the force Fz that has acted in the immediately preceding step ST2 is ΔFz. By using the amount of change ΔFz of the force as a parameter, the state can be identified accurately without being affected by the individual differences between workpieces 100. If the force Fz itself is used as a parameter, the threshold needs to be reset each time the type of workpiece changes. On the other hand, in the present embodiment, the amount of change ΔFz of the force is used as a parameter. Thus, even if the type of workpiece changes, the threshold does not need to be reset, and the state is easily identified. The moment Mx becomes a positive value when a rotation force in the positive Y-direction acts on the hand 12, and it becomes a negative value when a rotation force in the negative Y-direction acts on the hand 12. By determining whether the value of the moment Mx is positive or negative, the direction of misalignment of the workpiece 100 with respect to the axis CL3 can be identified.

In FIG. 5, mode MD2 is a state in which both the amount of change ΔFz of the force and the moment Mx are 0 or approximately 0. More specifically, mode MD2 is a state in which the amount of change ΔFz of the force is equal to or smaller than a positive predetermined value ΔF1 and the moment Mx is equal to or greater than a negative predetermined value M2 and equal to or smaller than a positive predetermined value M1. For example, mode MD2 corresponds to a non-contact state, in which the workpiece 100 is not in contact with the component 101. Mode MD1 is a state in which the amount of change ΔFz of the force is equal to or smaller than ΔF1 and the moment Mx is greater than M1. As shown in FIG. 5, mode MD1 corresponds to a state in which the workpiece 100 is buckled in the positive Y-direction. Mode MD3 is a state in which the amount of change ΔFz of the force is equal to or smaller than ΔF1 and the moment Mx is smaller than M2. As shown in FIG. 5, mode MD3 corresponds to a state in which the workpiece 100 is buckled in the negative Y-direction. Note that modes MD1 to MD3 also include states in which the amount of change ΔFz of the force is negative.

Mode MD5 is a state in which the amount of change ΔFz of the force is greater than ΔF1 and the moment Mx is equal to or greater than M2 and equal to or smaller than M1. As shown in FIG. 5, this state corresponds to a normal state, in which the workpiece 100 is normally press-fitted. Mode MD4 is a state in which the amount of change ΔFz of the force is greater than ΔF1 and the moment Mx is greater than M1. As shown in FIG. 5, mode MD4 corresponds to a bent state in which the workpiece is bent in the positive Y-direction. Mode MD6 is a state in which the amount of change ΔFz of the force is greater than ΔF1 and the moment Mx is smaller than M2. As shown in FIG. 5, mode MD6 corresponds to a bent state in which the workpiece is bent in the negative Y-direction.

The learning control unit 23 identifies the current half-mounted-state of the workpiece 100, that is, in which of the modes MD1 to MD6 the workpiece 100 is, on the basis of the force Fz and moment Mx detected by the force detector 15, more accurately, the amount of change ΔFz of the force and the moment Mx.

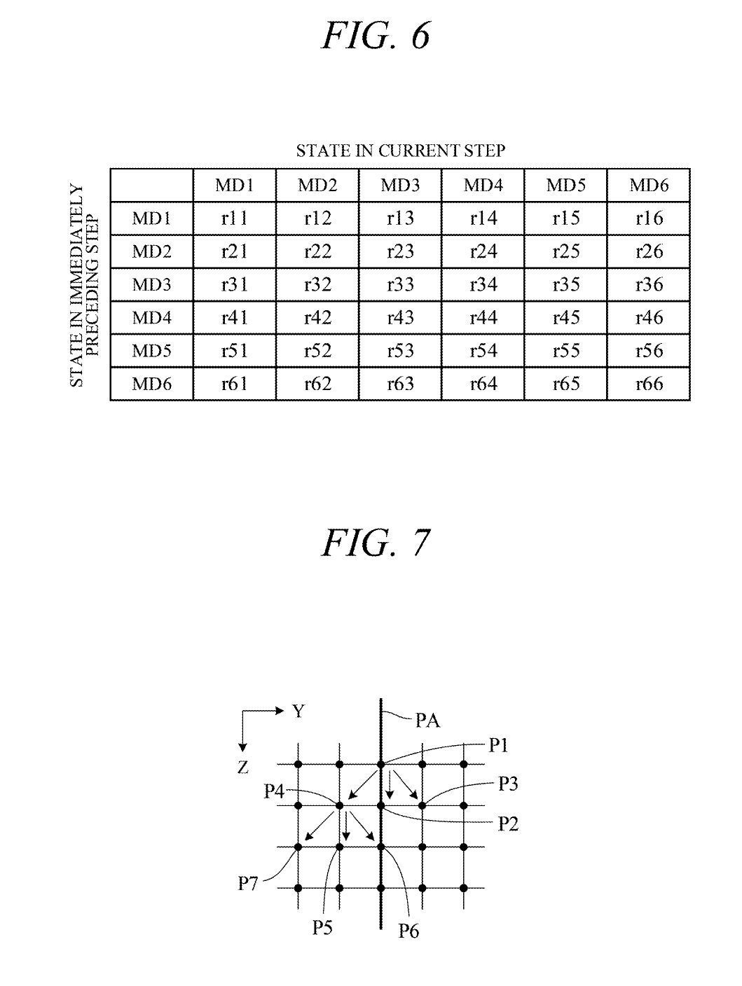

The reward r in the formula (I) is set using a reward table stored in the memory beforehand, that is, a reward table defined by the correspondence-relation between the state in the current step STₜ and the state in the immediately preceding step STₜ₋₁. FIG. 6 is a diagram showing an example of the reward table. If the state in the current step STₜ is a normal state (MD5), a predetermined value (e.g., +2) is set as the reward r (specifically, the reward r15, r25, r35, r45, r55, r65) in FIG. 6, regardless of the state in the immediately preceding step STₜ₋₁. In this case, a positive reward r is given.

If there is no change between the state in the current step STₜ and the state in the immediately preceding step STₜ₋₁ (e.g., both the state in the current step STₜ and the state in the immediately preceding step STₜ₋₁ are the buckling state MD1 or MD3), a predetermined value (e.g., −3) is set as the reward r (specifically, the reward r11, r22, r33, r44, r66). In this case, it is determined that the state would not be improved any more, and therefore a negative reward r is given. Otherwise (if the state is changed to a state other than the normal state MD5), 0 is set as the reward r. Note that the value of the reward r may be properly changed on the basis of the result of the actual press-fitting operation. The learning control unit 23 sets the reward r of the formula (I) in each step in accordance with the reward table in FIG. 6 and calculates the Q-value.

Next, the action of the robot 1 during mounting of the workpiece will be described. First, as shown in FIG. 4, a grid having predetermined intervals is defined along the reference movement path PA in the YZ-plane. FIG. 7 is a drawing showing a part of the grid in FIG. 4. As shown in FIG. 7, the intersection points (dots) of the grid correspond to the movement points of the front end of the hand. That is, the front end of the hand (reference point P0) moves on a dot by dot basis in steps ST1 to ST20, and the intervals between the dots correspond to the pitch by which the hand 12 moves.

For example, if the position of the front end of the hand (reference point P0) is point P1 on the reference movement path PA in FIG. 7 in the current step STₜ, the hand 12 moves to one of point P2 along the reference movement path PA, point P3 displaced from the reference movement path PA in the positive Y-direction by one pitch, and point P4 displaced from the reference movement path PA in the negative Y-direction by one pitch in the immediately following step STₜ₊₁. If the position of the front end of the hand is point P4 in the current step STₜ, the hand 12 moves to one of points P5, P6, and P7 in the immediately following step STₜ₊₁.

The directions in which the hand 12 can move (the angles indicating the movement directions) and the amount of movement of the hand 12 are stored in the memory beforehand. For example, 0° and ±45° with respect to the axis CL1 are set as the angles indicating the movement directions, and the length corresponding to the distance between the adjacent dots is set as the amount of movement. The learning control unit 23 operates the robot 1 such that a higher reward is obtained in accordance with those set conditions. The robot 1 is able not only to move the hand 12 but also to rotate it around the X-axis. Accordingly, the amount of rotation around the X-axis with respect to the movement direction of the hand 12 is also set in the controller 2.

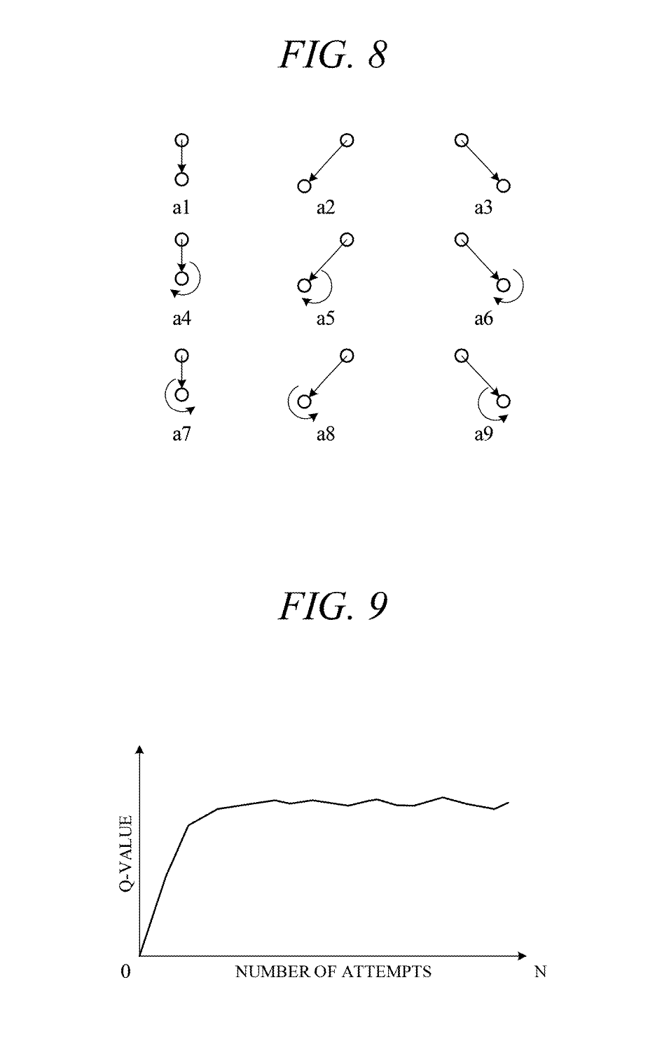

FIG. 8 is a drawing showing actions that the robot 1 can take during mounting of the workpiece. As shown in FIG. 8, the robot 1 is able to take nine actions a1 to a9 in each of steps ST1 to ST20. The action a1 corresponds to a movement from point P1 to point P2 and a movement from point P4 to point P5 in FIG. 7. The action a2 corresponds to a movement from point P1 to point P4 and a movement from point P4 to point P7 in FIG. 7. The action a3 corresponds to a movement from point P1 to point P3 and a movement from point P4 to point P6 in FIG. 7. The actions a4 to a6 include the movements based on the actions a1 to a3, as well as actions in which the hand 12 rotates clockwise around the X-axis. The actions a7 to a9 include the movements based on the actions a1 to a3, as well as actions in which the hand 12 rotates counterclockwise around the X-axis.

An operation as reinforcement learning can be performed by applying the nine possible actions a1 to a9 to each of the six possible half-mounted-states of the workpiece 100 (modes MD1 to MD6). However, in this case, a great number of state-action combinations are made, and it takes much time to perform the reinforcement learning step. For this reason, to reduce the time required to perform the reinforcement learning step, it is preferred to narrow down the actions in reinforcement learning.

The narrowing-down of actions is performed, for example, by causing an operator skilled in mounting a workpiece to mount a workpiece manually and grasping the pattern of the actions taken by him or her beforehand. Specifically, if there are actions that the operator has not selected in steps ST1 to ST20 in the period from the start to the end of mounting of the workpiece 100, such actions are removed. Thus, the actions are narrowed down.

For example, in steps ST1 to ST9 and steps ST13 to ST20 in FIG. 4, the operator selects only the actions a1 to a3 and does not select the actions a4 to a9. On the other hand, in steps ST10 to ST12, the operator selects only the actions a4 to a6 and does not select the actions a1 to a3 or actions a7 to a9. Accordingly, the workpiece mounting operation as reinforcement learning is limited such that only the actions a1 to a3 are applied in steps ST1 to ST9 and steps ST13 to ST20 and only actions a4 to a6 are applied in steps ST10 to ST12.

The actions applicable in steps ST1 to ST20 are set through the input unit 16 beforehand. The learning control unit 23 selects any action that allows for obtaining a positive reward, from these applicable actions and causes the robot 1 to take the selected action, as well as calculates the Q-value using the formula (I) each time it selects an action. The workpiece mounting operation as reinforcement learning is repeatedly performed until the Q-value converges in each of steps ST1 to ST20.

FIG. 9 is a graph showing the relationship between the number of operations (the number of attempts N) of the hand 12 in a certain step STₜ and the Q-value. The Q-value is 0 in the initial state, in which reinforcement learning has been started, and converges to a constant value as the number of attempts N is increased. A Q-table is constructed using the Q-values that have converged.

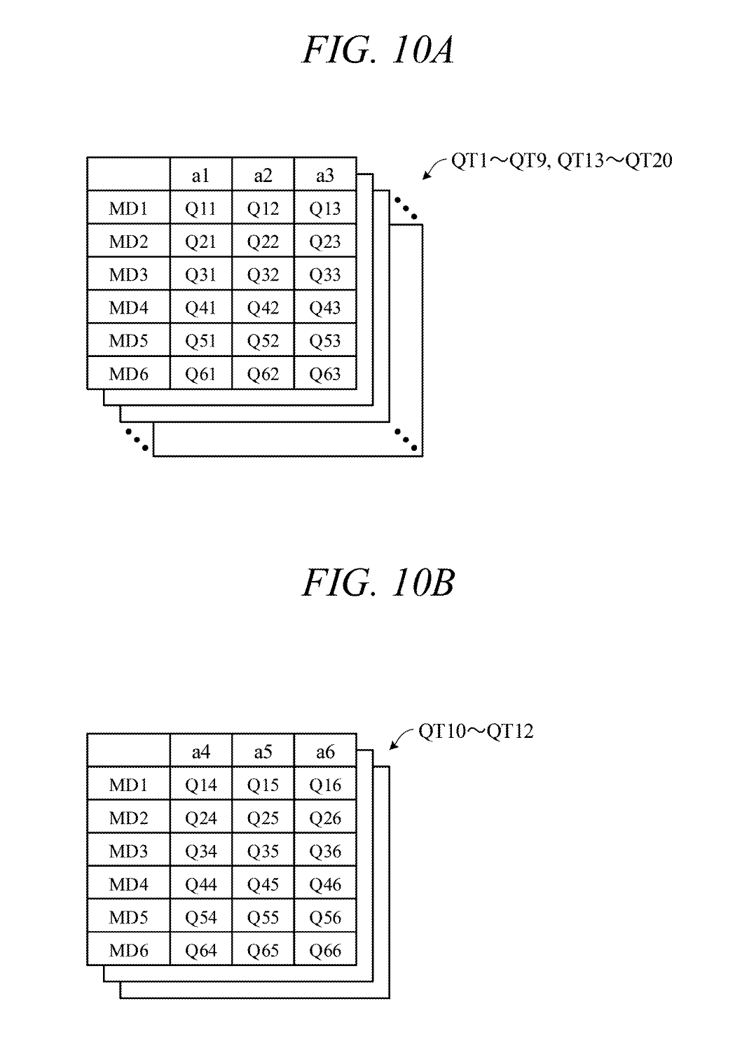

FIG. 10A and FIG. 10B are diagrams showing an example of the Q-table obtained in the reinforcement learning step. The Q-value is set in accordance with the state and action in each of steps ST1 to ST20. Specifically, considering the workpiece mounting operation performed by the operator, Q-tables QT1 to QT9 and QT13 to QT20 corresponding to the states (modes) MD1 to MD6 and the actions a1 to a3 are constructed in steps ST1 to ST9 and ST13 to ST20, as shown in FIG. 10A. Q-tables QT10 to QT12 corresponding to the states MD1 to MD6 and the actions a4 to a6 are constructed in steps ST10 to ST12, as shown in FIG. 10B. The constructed Q-tables QT1 to QT20 are stored in the memory unit 21 in FIG. 1.

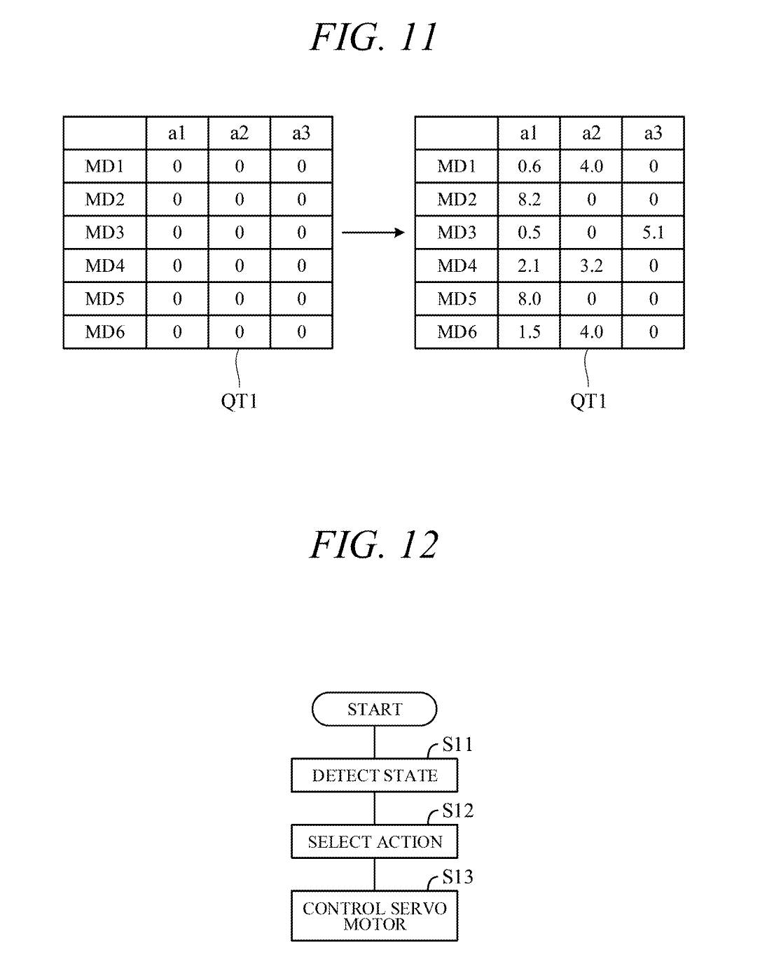

FIG. 11 is a diagram showing a specific example of the Q-table. This Q-table is, for example, the Q-table QT1 in step ST1. As shown in FIG. 11, in the initial state of the reinforcement learning step (the left side in FIG. 11), the Q-values are all 0. The Q-values are updated in the reinforcement learning step. When the Q-values converge (the right side of FIG. 11), the converged Q-table is stored in the memory unit 21. The normal control unit 24 in FIG. 1 selects an action having the highest Q-value in each states from among the Q-tables stored in the memory unit 21. For example, when in the state MD1, the action a2 is selected, and when in the state MD2, the action a1 is selected. The normal control unit 24 then controls the servo motor 13 so that the robot 1 performs the selected action.

FIG. 12 is a flowchart showing an example of processing performed by the normal control unit 24. The processing shown in this flowchart is started when a command to start a normal workpiece mounting operation is issued by operating the input unit 16 after the Q-table is stored in the reinforcement learning step. The processing in FIG. 12 is performed in each of steps ST1 to ST20.

First, in S11, the normal control unit 24 detects the current half-mounted-state of the workpiece 100, on the basis of a signal from the force detector 15. That is, it detects to which of modes MD1 to MD6 the workpiece 100 corresponds. Then, in S12, the normal control unit 24 reads a Q-table QT corresponding to the current step STₜ from the memory unit 21 and selects an action having the highest Q-value with respect to the detected half-mounted-state of the workpiece 100. Then, in S13, the normal control unit 24 outputs a control signal to the servo motor 13 so that the robot 1 takes the selected action.

A specific operation of the robot control apparatus according to the embodiment of the present invention will be described along with a robot control method.

### (1) Prior Step

First, before performing the reinforcement learning step, a skilled operator mounts the workpiece 100 to the component 101 manually as a prior step. At this time, the action pattern is analyzed while changing the state of the workpiece 100 to modes MD1 to MD6. Thus, the reference movement path PA (FIG. 4) through which the workpiece 100 moves when the robot 1 mounts the workpiece 100 and actions that the robot 1 can take in steps ST1 to ST20 can be determined. That is, the actions can be narrowed down such that the actions a1 to a3 are taken in steps ST1 to ST9 and ST13 to ST20 and the actions a4 to a6 are taken in steps ST10 to ST12. The determined reference movement path PA and the actions that the robot 1 can take, are set in the controller 2 through the input unit 16.

### (2) Reinforcement Learning Step

When the prior step is complete, the reinforcement learning step is performed. In the reinforcement learning step, the learning control unit 23 outputs a control signal to the servo motor 13 to cause the robot 1 to actually repeatedly mount the workpiece 100. At this time, the learning control unit 23 selects one of the multiple actions set in each of steps ST1 to ST20 beforehand and controls the servo motor 13 so that the robot 1 takes that action. The learning control unit 23 also grasps a change in the state in accordance with a signal from the force detector 15 and determines a reward r based on the change in the state with reference to the predetermined reward table (FIG. 6).

Then, using the reward r, the learning control unit 23 calculates a Q-value corresponding to the state and action in accordance with the formula (I) in each of steps ST1 to ST20.

In the initial state, in which the reinforcement learning has been started, the Q-value is 0, and the learning control unit 23 randomly selects an action in each of steps ST1 to ST20. As the reinforcement learning proceeds, the learning control unit 23 preferentially selects actions by which a higher reward r is obtained, and the Q-values of specific actions are gradually increased with respect to the states in steps ST1 to ST20. For example, if a bend or buckling (modes MD1, MD3, MD4, MD6) of the workpiece 100 due to a misalignment is corrected, a high reward r is obtained. Accordingly, the Q-value of an action that corrects the bend or buckling is increased. The Q-value gradually converges to a constant value (FIG. 9) by repeatedly performing workpiece 100 mounting and Q-value calculation. A Q-table QT is constructed using such Q-values and stored in the memory unit 21.

### (3) Mounting Step

When the reinforcement learning step is complete, the normal control unit 24 mounts the workpiece 100 as a mounting step. Specifically, the normal control unit 24 detects the half-mounted-state of the workpiece 100 in the current step STₜ in accordance with a signal from the force detector 15 (S11). The normal control unit 24 can identify the current step among ST1 to ST20, for example, in accordance with a signal from the encoder 14. The normal control unit 24 also selects, as the optimal action, an action having the highest Q-value from among multiple actions corresponding to the half-mounted-states of the workpiece 100 set in the Q-table (S12) and controls the servo motor 13 so that the robot 1 takes the optimal action (S13).

Thus, for example, if a misalignment occurs between the workpiece 100 and the component 101 due to the individual differences between workpieces 100, the normal control unit 24 is able to detect the misalignment and to cause the robot 1 to operate such that the robot 1 takes a proper action that corrects the misalignment. That is, the robot 1 is able to take the optimal action in accordance with a change in the state and to favorably press-fit the workpiece 100 into the component 101, regardless of the individual differences between workpieces 100. Even if the workpiece 100 is configured as a flexible tube, the normal control unit 24 can cause the robot 1 to press-fit the workpiece 100 while easily and properly correcting a bend or buckling of the workpiece 100.

According to the embodiment of the present invention, the following advantageous effects can be obtained:

(1) The robot control apparatus according to the embodiment of the present invention controls the robot 1 so that the workpiece 100 supported by the hand 12 of the robot 1 driven by the servo motor 13 is mounted on the component 101. The robot control apparatus includes the memory unit 21 that stores the correspondence-relation between the half-mounted-states (MD1 to MD6) of the workpiece obtained by the reinforcement learning beforehand and the optimal actions (a1 to a6) of the robot 1 that give the highest rewards to the half-mounted-states of the workpiece (Q-table), the force detector 15 that detects the half-mounted-state of the workpiece 100, and the normal control unit 24 that identifies the optimal action of the robot 1 corresponding to the half-mounted-state of the workpiece detected by the force detector 15 on the basis of the Q-table stored in the memory unit 21 and controls the servo motor 13 in accordance with this optimal action (FIG. 1).

As seen above, the robot control apparatus controls the servo motor 13 with reference to the Q-table obtained by the reinforcement learning. Thus, even if there is a misalignment between the central axis CL2 of the workpiece 100 and the axis CL3 of the component 101 due to the individual differences between workpieces 100, such as a bend tendency, the robot control apparatus is able to cause the robot 1 to easily and quickly press-fit the workpiece 100 into the component 101 while correcting the misalignment, without causing a bend, buckling, or the like in the workpiece 100. Also, there is no need to separately dispose a reaction force receiver or the like on the hand 12. This allows for simplification of the configuration of the hand 12, that is, allows for avoidance of upsizing of the hand 12.

(2) The optimal action of the robot 1 is defined by a combination of the angle indicating the movement direction of the hand 12, the amount of movement of the hand 12 along the movement direction, and the amount of rotation of the hand 12 with respect to the movement direction (FIG. 8). By defining the actions of the robot 1 in steps ST1 to ST20 using the movement direction, the amount of movement, and the amount of rotation as parameters, the robot 1 is able to easily perform operations such as press-fit of the flexible workpiece 100.

(3) The force detector 15 detects the translational forces Fx, Fy, and Fz and the moments Mx, My, and Mz acting on the hand 12, and identifies the half-mounted-state of the workpiece 100, on the basis of the detected translational force Fy and moment Mx (FIG. 5). This allows for detection of a bend, buckling, or the like of the workpiece 100 due to a misalignment of the workpiece 100 using a simple configuration, allowing for configuration of a cheaper device than a device using a camera or the like.

(4) The memory unit 21 stores the correspondence-relation between the multiple states of the workpiece 100 in the period from the start to the end of mounting of the workpiece 100 and the optimal actions of the robot 1, that is, the Q-table (FIG. 10A and FIG. 10B). This allows for selection of the optimal actions of the robot 1 corresponding to the half-mounted-states of the workpiece 100, in steps ST1 to ST20. This allows for quick correction of a misalignment of the workpiece 100, allowing for favorable press-fit of the workpiece 100 into the component 101.

(5) The robot control method according to the embodiment of the present invention is a method for controlling the robot 1 so that the workpiece 100 supported by the hand 12 of the robot 1 driven by the servo motor 13 is mounted on the component 101 (FIG. 1). This control method includes the reinforcement learning step of obtaining the correspondence-relation between the multiple half-mounted-states of the workpiece 100 and the optimal actions of the robot 1 that give the highest reward to the states (Q-table), by mounting the workpiece 100 on the component 101 multiple times by driving the hand 12; and the mounting step of detecting the half-mounted-state of the workpiece 100 on the component 101, identifying the optimal action corresponding to the detected state on the basis of the Q-table obtained in the reinforcement learning step, and controlling the servo motor 13 in accordance with the identified optimal action. That is, the Q-table is obtained in the reinforcement learning step beforehand, and the normal mounting operation is performed using the Q-table. Thus, even if there is a misalignment between the workpiece 100 and the component 101, the workpiece 100 can be easily and quickly press-fitted into the component 101 while correcting the misalignment.

(6) The robot control method according to the embodiment of the present invention further includes the prior step of mounting, by the operator, the workpiece 100 on the component 101 prior to the reinforcement learning step. The actions of the robot 1 in the reinforcement learning step is determined on the basis of the action pattern of the operator grasped in the prior step. Thus, the robot 1 is able to take actions similar to those of the skilled operator. Also, the actions of the robot 1 can be narrowed down such that the actions a1 to a3 are taken in steps ST1 to ST9 and steps ST13 to ST20 and the actions a4 to a6 are taken in steps ST10 to ST12. This allows for a reduction in the time required for the reinforcement learning step, allowing for efficient control of the robot 1.

### Modification

The above embodiment can be modified into various forms, and modifications will be described below. While, in the above embodiment, the controller 2 configured as a robot controlling apparatus includes the learning control unit 23 and normal control unit 24 and the learning control unit 23 performs a workpiece mounting operation as reinforcement learning, a different controller may perform such a workpiece mounting operation in place of the learning control unit 23. That is, the Q-table indicating the correspondence-relation between the half-mounted-states of the workpiece 100 and the optimal actions of the robot 1 may be obtained from the different controller and stored in the memory unit 21 of the robot control apparatus serving as a memory unit. For example, the same Q-table may be stored in the memory units 21 of mass-produced robot controllers at the time of shipment from the factory. Accordingly, the learning control unit 23 may be omitted from the controller 2 (FIG. 1).

While, in the above embodiment, the correspondence-relation between the half-mounted-states of the workpiece 100 and the optimal actions of the robot 1 are obtained using the Q-leaning, any technique other than Q-leaning may be used as reinforcement learning. Accordingly, the above correspondence-relation may be stored in the memory in a form other than the Q-table. While, in the above embodiment, the force detector 15 detects the half-mounted-state of the workpiece 100, a state detector is not limited to the force detector 15. For example, the half-mounted-state of the workpiece 100 may be detected by mounting a pair of vibration sensors on the peripheral surface of the base end of the workpiece 100 or the front end of the hand and detecting the moment on the basis of the difference between the times at which the pair of vibration sensor detect vibration.

While, in the above embodiment, the normal control unit 24 serving as an actuator controller identifies the optimal action of the robot 1 corresponding to the half-mounted-state of the workpiece 100 detected by the force detector 15 on the basis of the Q-table stored in the memory beforehand and controls the servo motor 13 in accordance with that optimal action, the actuator controller may be configured otherwise. The robot 1 may include an actuator (e.g., cylinder) of a type other than the servo motor 13, and the actuator controller may control such an actuator so that the robot 1 takes the optimal action. While, in the above embodiment, the half-mounted-states of the workpiece 100 are classified into the six modes MD1 to MD6, the states may be classified into any other type of modes depending on the material, shape, or the like of the workpiece 100.

While, in the above embodiment, the vertical articulated robot 1 is used as a robot, the robot may be configured otherwise. While, in the above embodiment, the flexible tube is used as the workpiece 100, the shape and material of a workpiece may be of any type. For example, the workpiece 100 may be a metal. While, in the above embodiment, press-fit of the tubular workpiece 100 (first component) into the pipe-shaped component 101 (second component) is assumed as a workpiece mounting operation, the first component and second component need not have such configurations and therefore the mounting operation performed by the robot need not be a press-fitting operation. The robot control apparatus and robot control method of the present invention can be also applied to other types of operations.

The above description is only an example, and the present invention is not limited to the above embodiment and modifications, unless impairing features of the present invention. The above embodiment can be combined as desired with one or more of the above modifications. The modifications can also be combined with one another.

### REFERENCE SIGNS LIST

1 robot, 2 controller, 12 hand, 13 servo motor, 15 force detector, 21 memory unit, 24 normal control unit, 100 workpiece, 101 component

1-6. (canceled)

7. A robot control apparatus configured to control a robot so as to mount a first component supported by a hand of the robot driven by an actuator to a second component, comprising:
a detector configured to detect a half-mounted-state of the first component; and
a controller having a microprocessor and a memory, wherein
the memory is configured to store a correspondence-relation between a plurality of half-mounted-states of the first component and an optimal action of the robot giving the highest reward for each of the plurality of half-mounted-states obtained beforehand by reinforcement learning, and wherein
the microprocessor is configured to identify an optimal action of the robot corresponding to the half-mounted-state detected by the detector based on the correspondence-relation stored in the memory and to control the actuator in accordance with the optimal action.

8. The robot control apparatus according to claim 7, wherein
the optimal action is defined by a combination of an angle indicating a movement direction of the hand, a movement amount of the hand along the movement direction, and a rotation amount of the hand relative to the movement direction.

9. The robot control apparatus according to claim 7, wherein
the detector further configured to detect a translational force and a moment acting on the hand to detect the half-mounted-state of the first component based on the translational force and the moment detected.

10. The robot control apparatus according to claim 7, wherein
the memory further configured to store the correspondence-relation between the plurality of half-mounted-states of the first component from a start of mounting to an end of mounting and an optimal action corresponding to each of the plurality of half-mounted-states.

11. The robot control apparatus according to claim 9, wherein
each of the plurality of half-mounted-states of the first component is defined in a plane defined based on the translational force and the moment detected by the detector, in which a misalignment occurs between an axis of the hand and an axis of the second component, and wherein
the microprocessor is further configured to identify the optimal action in the plane.

12. The robot control apparatus according to claim 9, wherein
the detector comprises a 6-axis force sensor disposed on an end of the hand.

13. A robot control apparatus configured to control a robot so a to mount a first component supported by a hand of the robot driven by an actuator to a second component, comprising:
a detector configured to detect a half-mounted-state of he first component; and
a controller having a microprocessor and a memory, wherein
the memory is configured to function as a memory unit configured to store a correspondence-relation between a plurality of half-mounted-states of the first component and an optimal action of the robot giving the highest reward for each of the plurality of half-mounted-states obtained beforehand by reinforcement learning, and wherein
the microprocessor is configured to function as an actuator controller configured to identify an optimal action of the robot corresponding to the half-mounted-state detected by the detector based on the correspondence-relation stored in the memory and to control the actuator in accordance with the optimal action.

14. The robot control apparatus according to claim 13, wherein
the optimal action is defined by a combination of an angle indicating a movement direction of the hand, a movement amount of the hand along the movement direction, and a rotation amount of the hand relative to the movement direction.

15. The robot control apparatus according to claim 13, wherein
the detector further configured to detect a translational force and a moment acting on the hand to detect the half-mounted-state of the first component based on the translational force and the moment detected.

16. The robot control apparatus according to claim 13, wherein
the memory unit further configured to store the correspondence-relation between the plurality of half-mounted-states of the first component from a start of mounting to an end of mounting and an optimal action corresponding to each of the plurality of half-mounted-states.

17. The robot control apparatus according to claim 15, wherein
each of the plurality of half-mounted-states of the first component is defined in a plane defined based on the translational force and the moment detected by the detector, in which a misalignment occurs between an axis of the hand and an axis of the second component, and wherein
the actuator controller is further configured to identify the optimal action in the plane.

18. The robot control apparatus according to claim 15, wherein
the detector comprises a 6-axis force sensor disposed on an end of the hand.

19. A robot control method controlling a robot so as to amount a first component supported by a hand of the robot driven by an actuator to a second component,
the robot control method comprising:
a reinforcement learning step acquiring a correspondence-relation between a plurality of half-mounted-states of the first component and an optimal action of the robot giving the highest reward for each of the plurality of half-mounted-states by mounting the first component to the second component multiple times by driving the hand; and
a mounting step, when mounting the first component to the second component, detecting a half-mounted-state of the first component, identifying an optimal action corresponding to the half-mounted-state detected based on the correspondence-relation acquired in the reinforcement learning step, and controlling the actuator in accordance with the optimal action identified.

20. The robot control met hod according to claim 19, further comprising:
a prior step mounting the first component to the second component by an operator before performing the reinforcement learning step, wherein
an action of the robot in the reinforcement learning step is determined based on an action pattern of the operator grasped in the prior step in the reinforcement learning step.

21. The robot control method according to claim 20, wherein
the action of the robot in the reinforcement teaming step is determined excluding actions not selected by the operator based on the action pattern of the operator grasped in the prior step in the reinforcement learning step.
